(19) United States
(12) Patent Application Publication
(10) Pub. No.: US 2015/0175022 A1
(43) Pub. Date: Jun. 25, 2015

(54) PTO DRIVEN DC GENERATOR FOR ELECTRIC VEHICLE CHARGING

(71) Applicant: Contour Hardening, Inc., Indianapolis, IN (US)

(72) Inventors: John M. Storm, Danville, IN (US); Adam Sheer, Columbia, MD (US)

(21) Appl. No.: 14/580,392

(22) Filed: Dec. 23, 2014

Related U.S. Application Data
(60) Provisional application No. 61/919,898, filed on Dec. 23, 2013.

(51) Int. Cl. B60L 11/18

(52) U.S. Cl. CPC B60L 11/1816

(57) ABSTRACT

Disclosed is a DC electrical power generation system mounted on a rescue vehicle, the rescue vehicle having a prime mover controlled by a prime mover controller and a power take off operable to transfer rotational energy from the prime mover. The DC electrical power generation system comprises a DC electrical generator having a generator input connected to the power take off and operable to produce DC electrical energy at a target voltage when rotated at a target speed. The DC-DC converter has an input connected to the output of the DC electrical generator and is operable to convert a generator output voltage of the DC electrical generator to a voltage suitable for charging an electric vehicle when a battery pack of the electric vehicle is connected to the output of the DC-DC converter.

### CROSS-REFERENCE TO RELATED APPLICATION

This application claims the benefit of U.S. Provisional Application Ser. No. 61/919,898 filed Dec. 23, 2013 which is hereby incorporated by reference.

### BACKGROUND

The present disclosure relates to electric generators and more specifically, to DC power generation systems for charging electric vehicles.

With increased use of electric vehicles, there is a need for charging systems which can rapidly recharge the batteries of such vehicles. Typical charging facilities are based on a permanent fixed installation, such as in a consumer's home or at a dedicated facility, similar to a common gas station. Without some other option, an electric vehicle that loses its charge and becomes stranded far from the charging facility will have to be towed to the charging facility in order to be recharged. This causes a great deal of expense for the vehicle owner, in addition to the stress and uncertainty due to the possibility of becoming stranded.

Thus, there is a need to be able to deliver electric recharging power to vehicles which have become stranded away from permanent or fixed charging facilities.

### SUMMARY OF THE DISCLOSURE

This disclosure relates to a DC electrical generator system which is mounted to a rescue vehicle and provides recharging power to a separate electric vehicle. The rescue vehicle includes a transmission having a power take off (PTO). The PTO drives a DC generator, which produces DC power. Power from the DC generator is converted to an acceptable voltage and current level by a DC-DC converter and directed to the input terminal of an electric vehicle for charging the battery pack of the electric vehicle.

### BRIEF DESCRIPTION OF THE DRAWINGS

FIG. 1 is a schematic drawing of one embodiment of a system of the present disclosure depicting a DC power generation system for charging an electric vehicle.

FIG. 2 is an enlarged longitudinal fragmentary sectional view of a power take off (PTO).

FIG. 3 is a partial, diagrammatic, top plan view of a rescue vehicle in which a DC power generation system according to the present disclosure is installed.

FIG. 4 is a partial, diagrammatic, side elevational view of a rescue vehicle in which a DC power generation system according to the present disclosure is installed.

FIG. 5 is side elevational view of the rescue vehicle of FIG. 4 with a stranded electric vehicle connected to the DC power generation system according to the present disclosure.

### DETAILED DESCRIPTION OF THE DRAWINGS

For the purpose of promoting an understanding of the disclosure, reference will now be made to certain embodiments thereof and specific language will be used to describe the same. It will nevertheless be understood that no limitation of the scope of this disclosure is thereby intended, such alterations, further modifications and further applications of the principles described herein being contemplated as would normally occur to one skilled in the art to which the disclosure relates. In several FIGs., where there are the same or similar elements, those elements are designated with similar reference numerals.

The present disclosure relates to coupling a DC generator to a prime mover to produce DC power for charging a battery pack of an electric vehicle which is in need of charging or has become stranded. By using a DC generator to produce the DC charging power, the need for complicated AC-DC conversion systems is eliminated. As used herein, the term “electric vehicle” means a vehicle that can use electrical energy to motivate the vehicle. Electric vehicles can includes pure electric vehicles, hybrids, or other combinations of electric and other power sources.

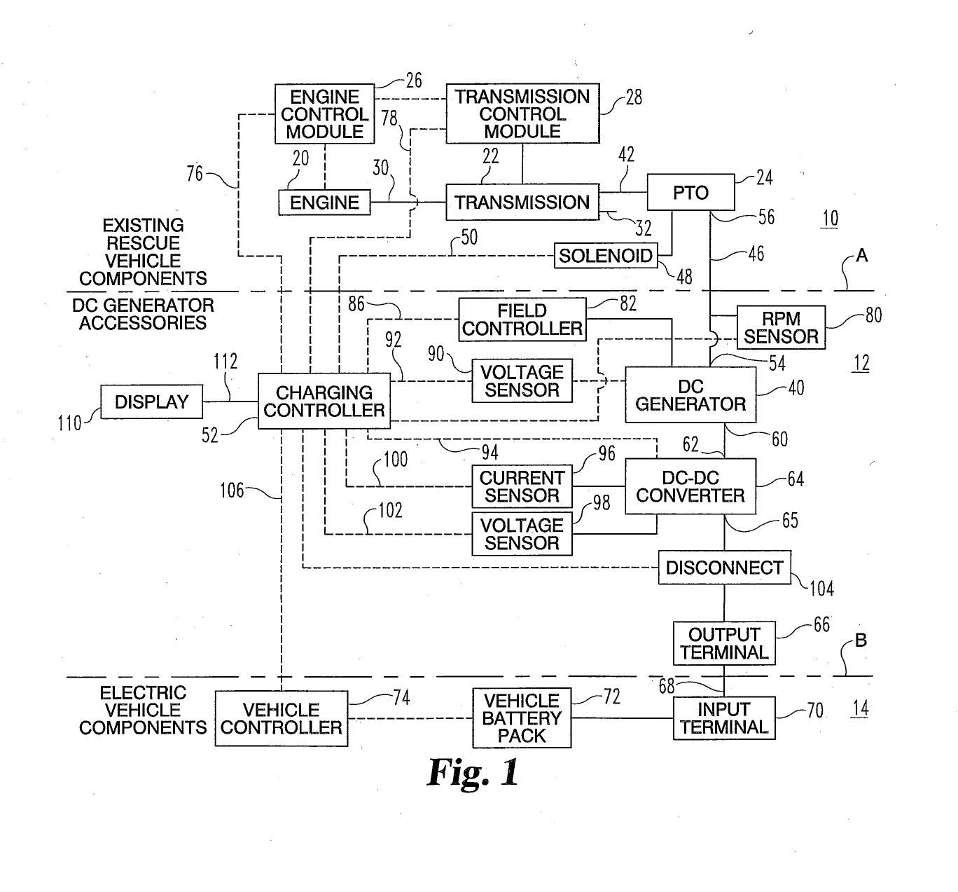

FIG. 1 illustrates a rescue vehicle system 10 wherein a DC electrical generating system 12 is incorporated. Existing rescue vehicle components are illustrated demarcated from DC electrical generating system 12 by reference line A. The existing rescue vehicle components include engine 20, transmission 22, power take off (PTO) 24, engine control module (ECM) 26, and transmission control module (TCM) 28. Engine 20 is coupled to transmission 22 though mechanical output 30. The engine 20 and transmission 22 serve as the prime movers for the rescue vehicle system 10. It is noted that, while FIG. 1 describes the incorporation of a DC power generation system 12 into a preexisting vehicle which likely includes an independent system for generating electricity, the disclosure herein is not so limited. It is envisioned that the systems disclosed herein could be incorporated into a vehicle as a part of the original vehicle design, with the disclosed DC electrical generating system 12 either providing additional capacity for electrical generation, or replacing all other electrical generating systems. Furthermore, the system 10 may be implemented on a stationary platform, such as a portable skid having a prime mover mounted thereon, as opposed to a vehicle.

Engine 20 may be any one of a variety of prime movers including spark-ignited gasoline or natural gas fueled engines or compression ignition diesel engine. As used herein, the term “prime mover” shall be understood to include any power device suitable for providing a mechanical rotary output to drive a rotary input of an electrical generator. It shall be further understood that the engine 20 may comprise the prime mover of a vehicle or a prime mover mounted to a stationary skid or platform. Similarly, transmission 22 may be one of a variety of transmissions but is shown here as an automatic transmission providing rotatable output shaft 32, which may be coupled to a differential (not illustrated) as known in the art. Transmission 22 preferably includes provisions to add PTO 24, which is a standard feature in class 6 and above truck transmissions. PTO 24 is driven by the transmission 22 via link 42. However, use of PTO 24 is not required as described herein. Transmission 22 may also be omitted in certain embodiments, such as when the system 10 is implemented as on a stationary platform or portable skid. As used herein, the term “prime mover controller” shall be understood to include the functions of the engine control module 26 and/or transmission control module 28.

Still referring to FIG. 1, the DC generator system 12 includes a DC generator 40 sized according to the capacity required to perform various levels of electric vehicle battery charging. For example, it has been found that a 75 kilowatt DC generator will produce sufficient current to perform Level 3 charging, as defined by the CHAdeMO or SAE J1772-3 standards. Level three charging (voltage, current) will charge a typical electric vehicle to 80% capacity in approximately 15 minutes.

In the illustrated embodiments, DC generator 40 is positioned in the vehicle outside of the compartment for the prime mover, consisting of engine 20 and transmission 22. However, it should be noted that DC generator 40 could be positioned almost anywhere, including within the compartments of the prime mover if space allows or if the disclosed system is incorporated in the original vehicle design.

DC generator system 12 is coupled to the prime mover (engine 20 and transmission 22) at PTO 24 via link 46. In certain embodiments, additional gearing may be connected between PTO 24 and DC generator 40 to provide further flexibility and control of the DC Generator 40 speed in relation to the PTO shaft speed.

PTO 24 is selectively engaged or disengaged from transmission 22 and output 42 using solenoid 48. Solenoid 48 is of a type that is biased to a disengaged position in the absence of an electrical signal then urged to an engaged position when the electrical signal is sent to solenoid 48 via line 50. Powering the coil in solenoid 48 through line 50 results in PTO 24 coupling to output 42. Solenoid 48 in an unpowered state would leave PTO 24 uncoupled. Line 50 connects solenoid 48 to charging controller 52, which enables engagement of solenoid 48, and therefore mechanical operation of PTO 24 and DC generator system 12, only when certain conditions exist as described herein. It shall be understood that other types of actuators may be used to engage or disengage the PTO 24.

While the mechanical input for DC generator system 12 is illustrated as coming from PTO 24, an alternative mechanical input might also be derived from any convenient output of the engine including a primary output of a split transmission, accessory gearboxes, accessory belt drives and the like.

DC generator 40 has a mechanical input 54 which is adapted to be rotated by output 56 of PTO 24. Input 54 is coupled to the PTO 24 via an appropriate mechanical link such as link 46. In the illustrated embodiment, a direct mechanical coupling is utilized. The actual form of the mechanical link is dependent in part on the space available to install the DC generator system 12. Some possible methods for mechanically linking mechanical input 54 to output 56 include direct drive shaft, offset drive shaft, belt and pulleys or a gear box, as are known in the art.

The electrical output 60 of DC generator 40 is connected to the input 62 of a DC-DC converter 64. DC-DC converter 64 converts the voltage at input 62 to a voltage required by the electric vehicle charging mode. For example, with “Level 3 Charging,” as defined by the CHAdeMO and SAE J1772-3, the required voltage is in the range of 330-600 volts. DC-DC converter 64 may be implemented as any DC voltage conversion device known in the art and may include capacitor banks, resistor banks, and the like.

The output 65 of DC-DC converter 64 is connected to output terminal 66 through disconnect 104. In one embodiment, output terminal 66 is in the form of an electrical receptacle. Cable 68 is used to connect the output terminal 66 to an input terminal 70 of electric vehicle 14 being charged. The components of DC power generation system 12 are illustrated demarcated from the components of the electric vehicle 14 by reference line B. It is envisioned that the output terminal 66 may be physically configured to conform to a particular vehicle charging standard, such as CHAdeMO or SAE J1772-3. In certain embodiments, multiple input terminals 70 may be provided to allow either a CHAdeMo or SAE J1772-3 type cable to be used. A selector switch may also be provided to allow the user to select which of the multiple output terminals 66 is being used.

The input terminal 70 is electrically connected to the vehicle battery pack 72 as shown, thereby delivering the charging voltage/current from the DC-DC converter 64 to the battery pack 72. Electric vehicle controller 74 is in operative communication with the charging controller 52 via line 106. Electric vehicle controller 74 monitors the vehicle battery pack 72 and adjust the amount of current being requested from the DC power generation system 12.

The voltage produced by the DC generator 40 at output 60 is primarily dependent on two factors: the speed of the generator and the strength of the generator field. To achieve the generator speed needed to produce a given voltage at output 60, the charging controller 52 communicates with the ECM 26 and/or TCM 28 via lines 76 and 78 respectively. The communication between charging controller 52 and the ECM 26 or TCM 28 may be accomplished using the controller area network (CAN) protocol (defined by SAE J1939) or other standard automotive communication protocols known in the art. The modules 26 and 28 in turn cause the engine 20 and/or transmission 22 to operate to produce the desired rotational speed at the output 56 of PTO 24. The charging controller 52 receives the measured rotational speed of the DC generator 40 from RPM sensor 80, which is operatively coupled to the link 46 or DC generator 40.

If adjustment of the generator field is needed, which will also affect the generator output voltage, charging controller 52 communicates with field controller 82, via line 86, which in turn adjusts the field strength of the generator 40. Field controller 82 may comprise a DC power supply capable of producing a selected voltage in the generator field windings. In other embodiments, field controller 82 may be implemented by connecting a portion of the output voltage of the DC generator 40 to the field windings. Voltage sensor 90 is operatively coupled to the DC generator 40 and provides feedback of the measured generator voltage to the charging controller 52 via line 92. It is envisioned that the output voltage of the DC generator 40 may be adjusted by changing the speed of the DC generator 40, changing the field strength of DC generator 40, or a combination of both methods.

The charging controller 52 is also in communication with DC-DC converter 64 via line 94. Current sensor 96 and voltage sensor 98, via lines 100 and 102 respectively, provide input to the charging controller 52 with regard to the current and voltage being output by the DC-DC converter 64.

Charging controller 52 monitors rescue vehicle system 10 and DC generator system 12 and includes various interlocks to prevent operation in unsafe conditions. Charging controller 52 is coupled to solenoid 48 through line 50 and only energizes solenoid 48 when all other interlocks are met. Charging controller 52 may also cause the output of DC-DC converter 64 to be disconnected from the output terminal 66 by opening disconnect 104 if an unsafe condition is detected. The charging controller 52 preferably includes a computer processor and memory suitable for achieving the control and monitoring of the various components within the system 10.

Also preferably included is display 110, which is coupled to charging controller 52 by line 112. Display 110 can be advantageously located near an operator, possibly within the control cab of the rescue vehicle or near the output terminal 66 so that the operator receives feedback regarding power generation by DC power generation system 12. Display 110 may also include an operator interface to allow the operator to control the operation of DC generator system 12. For example, the operator interface may permit the operator to actuate solenoid 48 to engage or disengage PTO 24 from transmission 22 (assuming all interlocks are permissive).

In operation, charging controller 52 receives a request for a given amount of current (at the given charging voltage) from the electric vehicle controller 74. This communication is preferably achieved using a standard digital communication protocol for communication between electric vehicles and electric vehicle charging equipment, such as the CAN protocol. The charging controller than directs the ECM 26 and/or TCM 28 to operate the engine 20 and/or transmission 22 such that the PTO 24 will cause the DC generator to rotate at a desired speed. The charging controller 52 monitors the DC generator 40 speed and output voltage, via RPM sensor 80 and voltage sensor 90, and makes any required adjustments to maintain the desired generator output voltage. As discussed above, the DC generator 40 voltage may be regulated by adjusting the generator speed or by adjusting the generator field using field controller 82. The charging controller 52 also communicates with the DC-DC converter 64 to ensure that the requested amount of current and voltage is being supplied by the DC-DC converter 64 at output terminal 66. After the electric vehicle controller 74 indicates that the charge is complete, the charging controller de-energizes solenoid 48 to uncouple PTO 24 and/or opens disconnect 104. The charging controller 52 may further provide an indication of the charge complete status using display 110.

The control system embodied by FIG. 1 may be tuned and refined to determine the relationship between the DC generator 40 speed and output voltage (at a given field strength), and further the output voltage of the DC-DC converter 64. This relationship may be preprogrammed into the charging controller 52 or adaptively learned by the charging controller 52 through continued use. The above described control operation may be contained within a computer program or algorithm embodied within the charging controller 52. The charging controller 52 receives input signals from the various sensors and peripheral controllers of the system 10. The input signals are then processed and transformed using the processor and memory within the charging controller 52 according to the algorithm to produce the required output signals. The output signals are then applied to the various control devices to regulate the DC generator 40 output and provide the desired charging rate within the electric vehicle 14. It is envisioned that the functionality of charging controller 52 may be incorporated into ECM 26 or TCM 28 in certain embodiments.

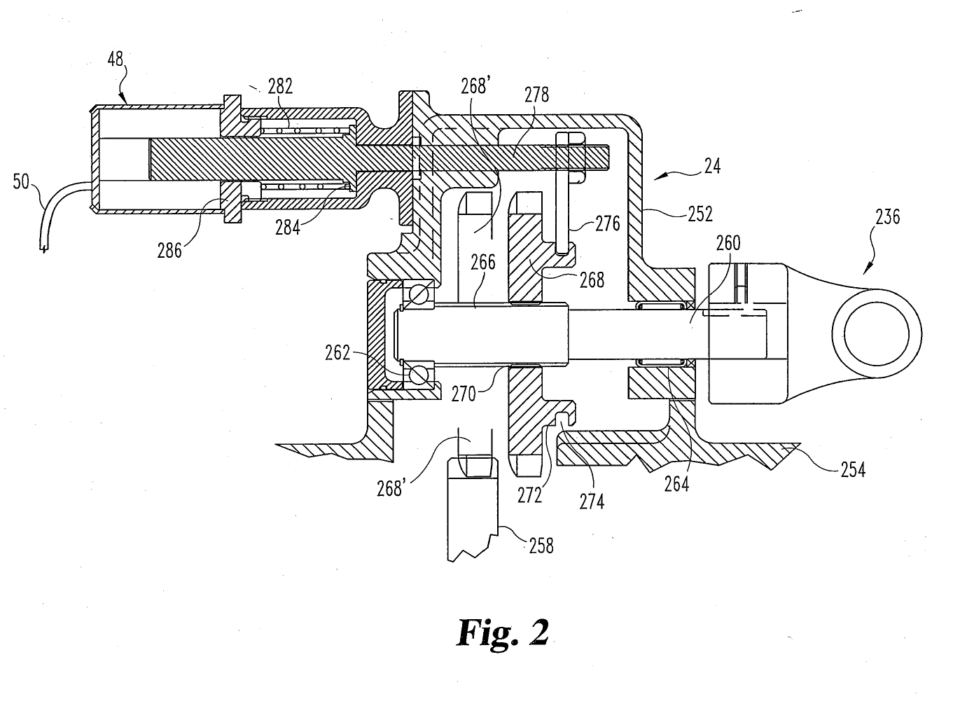

PTO 24 is disclosed as being engageable and disengageable with output 42 from transmission 22. FIG. 2 illustrates one implementation of this feature. Housing 252 is secured to transmission housing 254 by appropriate means (not illustrated). Housing 252 is positioned over a transmission PTO drive gear 258. Output shaft 260 is journaled in housing 252 by appropriate bearings 262 and 264 to output shaft 260 on an axis parallel to the axis of transmission 22. The end of output shaft 260 extends from housing 252 and connects with universal joint 236. Output shaft 260 has an elongated splined section 266 on which a spur gear 268 is telescoped. Spur gear 268 has internal splines 270 which cause spur gear 268 to rotate with output shaft 260 but permits it to be axially displaceable from the solid position shown in FIG. 2.

The solid position shown in FIG. 2 illustrates where DC power generation system 12 is disengaged from the prime mover with spur gear 268 located in the far right position spaced apart from PTO drive gear 258. FIG. 2 also illustrates where DC power generation system 12 is engaged with the prime mover when spur gear 268′, indicated by partial lines, is located in the far left position engaged with PTO drive gear 258.

Spur gear 268 has an integral extension 272 and groove 274 which receives fork 276. Fork 276 is secured to moveable output shaft 278 of solenoid 48. Output shaft 278 of solenoid 48 is biased to its solid position shown in FIG. 2 by spring 282 acting against a flange 284 on output shaft 278 and end wall 286 in solenoid 48. Solenoid 48 then holds spur gear 268 in its disengaged position by virtue of spring 282 and when electrical power is applied to solenoid 48 by line 50, output shaft 278 is displaced to the left as shown in FIG. 2, thus meshing spur gear 268 with transmission PTO drive gear 258 to cause output shaft 260 and universal joint 236 to rotate. Universal joint 236 is coupled to other components of DC power generation system 12 as described herein.

The size and/or number of teeth of meshing spur gear 268 and transmission PTO drive gear 258 can be varied as necessary to set the transmission ratio of PTO 24.

It should be noted that housing 252 of PTO 24 preferably has an angled outer configuration so as to clear the existing wall of the prime mover compartment. This is particularly advantageous for applications where the PTO is desired to be taken off of a side of the transmission opposite to the provision made by the original equipment manufacturer.

While PTO 24 has been depicted and described herein as utilizing a disengageable meshing spur gear, other means of controlling the engagement of PTO 24 are known in the art. For example, the use of a hydraulically powered clutch plate is a system for engaging a PTO known in the art.

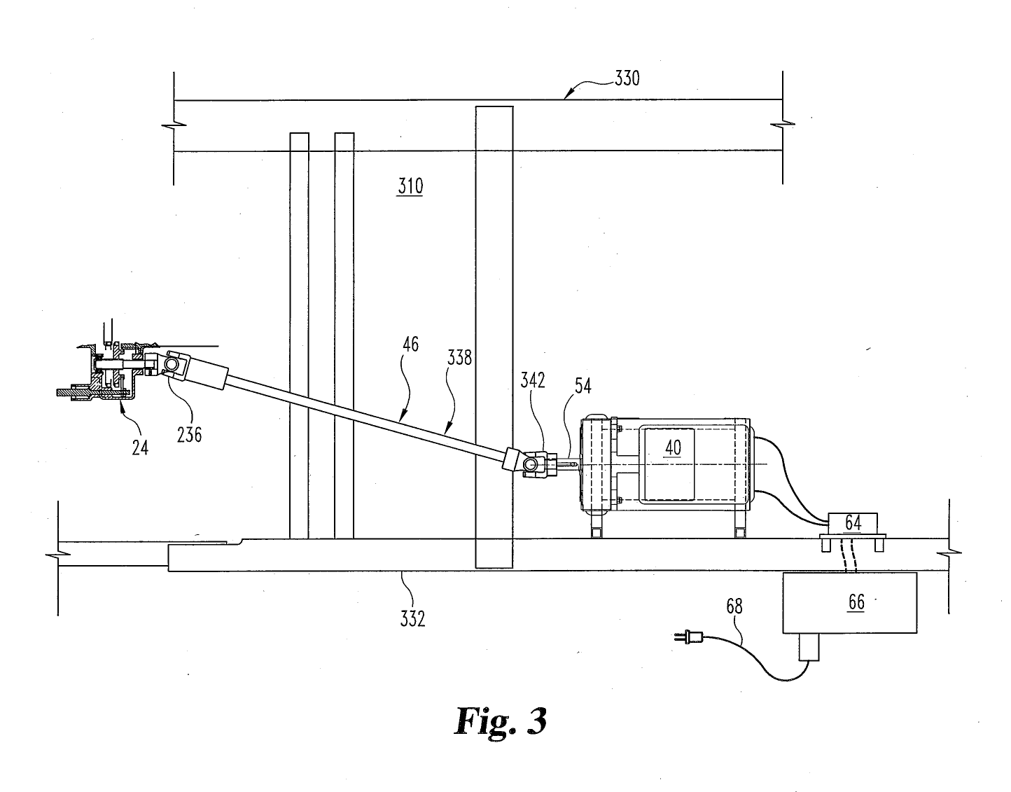

Turning now to FIG. 3, one embodiment of rescue vehicle system 10 integrated with DC power generation system 12 is depicted on rescue vehicle 310. Vehicle 310 has a pair of frame rails 330 and 332, which are generally parallel to each other and form the structural support for many vehicles. Within frame rails 330 and 332, engine 20 (not shown) is mounted along with transmission 22 (not shown).

Transmission 40 is preferably oriented and mounted in such a way that output shaft 32 is generally parallel to the longitudinal access of frame rails 330 and 332. It should be noted that engine 20 and transmission 22 can be oriented in any way and still achieve benefits of the present disclosure. Output shaft 32 is not shown in FIG. 3 in order to simplify an understanding of the present disclosure. However, it should be apparent to those skilled in the art that output shaft 32 will drive a differential axle at the rear of the vehicle. In other embodiments vehicle 310 may have additional outputs to provide all-wheel-drive by connecting output shaft 32 to a similar differential or drive arrangement at the front of the vehicle. As illustrated in FIG. 3, transmission 22 is an automatic transmission manufactured by Allison Division of General Motors. However it should be apparent that other transmission brands may be used with equivalent advantages. Transmission 22 has a standard mounting plate for mounting a power take off unit that is equivalent for all commercially available transmissions. Transmission 22 also includes power take off drive gear 258 as described above.

As shown, particularly in FIG. 3, PTO 24 has universal joint 236 coupled to output shaft 260 (as specifically illustrated in FIG. 2). Universal joint 236 is connected to torque tube 338 extending aft from the vehicle compartment that substantially houses the prime mover consisting of engine 20 and transmission 22. Torque tube 338 extends to universal joint 342, which is connected to input shaft 54, forming the input to DC generator 40.

While torque tube 338 is utilized in the illustrated embodiment to couple PTO 24 to DC generator 40, other linkages would be appropriate in various circumstances. For example, in order to optimally locate required components, PTO 24 could be coupled to DC generator 40 by a belt and pulley drive system, a gearbox, or any other mechanical linkage known in the art.

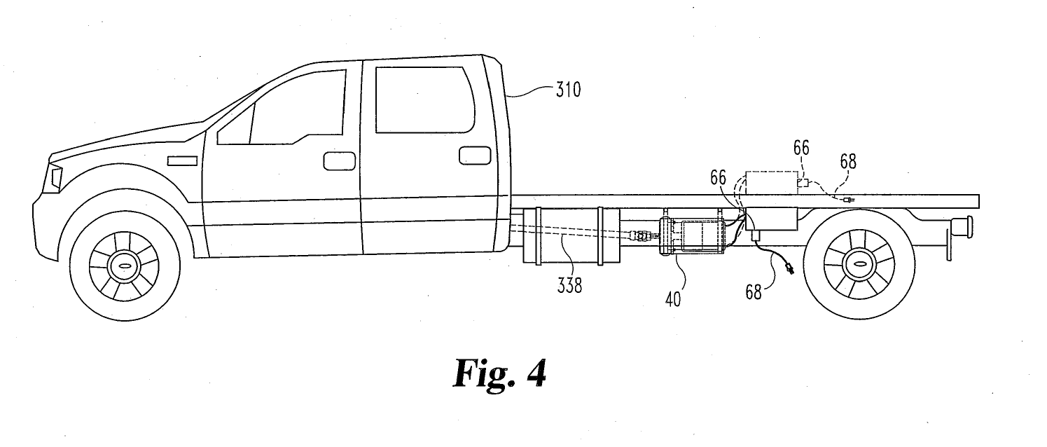

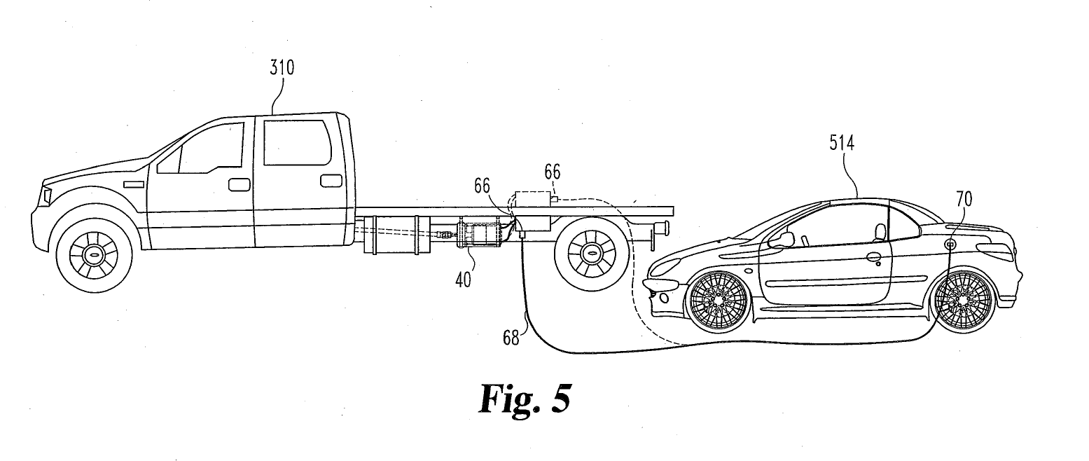

As illustrated in FIG. 3, DC generator 40 is mounted to the inner portion of the frame rail 330 and generally parallel to the longitudinal access of frame rails 330 and 332. However other mounting orientations may also be used depending on the available mounting space and clearances of the particular rescue vehicle. Also, DC-DC converter 64 is preferably mounted nearby and connected to the DC generator 40. The output terminal 66 is connected to the DC-DC converter and preferably mounted to the vehicle 310 in a location which provides easy access for the operator when connecting charging cable 68 to the output terminal 66. FIG. 4 shows a side view of the rescue vehicle 310 with the DC power generation system 12 installed. The output terminal 66 is illustrated in FIG. 4 in two alternate locations, below the vehicle bed and above the vehicle bed, however other mounting locations are contemplated to be within the scope of the present disclosure. FIG. 5 illustrates a side view of an electric vehicle 514 connected to the DC power generation system 12 of rescue vehicle 310.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

I claim:

1. A mobile electric vehicle charging system, comprising:
a DC electrical power generation system mounted to a rescue vehicle, the rescue vehicle having a prime mover controlled by a prime mover controller and a power take off (PTO) operable to transfer rotational energy from the prime mover, the DC electrical power generation system including:
a DC electrical generator having a generator input connected to the power take off and the DC electrical generator operable to produce DC electrical energy at a target voltage when rotated at a target speed; and
a DC-DC converter having an input connected to an electrical output of the DC electrical generator and operable to convert a generator output voltage of the DC electrical generator to a voltage suitable for charging an electric vehicle when the electric vehicle is connected to an output of the DC-DC converter.

2. The system of claim 1, wherein the system is configured and arranged to produce at least ninety kW of electrical output power from the DC-DC converter continuously for at least ten minutes.

3. The system of claim 2, wherein said system is further configured and arranged to deliver at least two hundred amps of current to said electric vehicle continuously for at least ten minutes.

4. The system of claim 1, wherein the system further includes a J1772 compliant or a CHAdeMO compliant electrical connector.

5. The system of claim 1, further comprising a charge controller electrically coupled to the output of the DC-DC converter and communicatively coupled to the prime mover controller, the charge controller and prime mover controller collectively configured and arranged to alter the speed of rotation of the power take off to alter the charging power output of the system.

6. The system of claim 5, wherein the charge controller is further configured to electrically communicate with said electric vehicle.

7. The system of claim 6, wherein the charge controller is further configured to effectuate the alteration of the charging power output of the system in response to information received from said electric vehicle.

8. The system of claim 1, wherein said prime mover includes an internal combustion engine.

9. The system of claim 1, wherein the PTO further comprises an engagement mechanism, the engagement mechanism configured and arranged to enable engagement and disengagement of the PTO and the DC electrical generator.

10. The system of claim 9, wherein the PTO further comprises a solenoid that through electrical stimulation engages or disengages said engagement device.

11. A stationary electric vehicle charging system, comprising:
a DC electrical power generation system mounted to a stationary skid, including:
a prime mover controlled by a prime mover controller and having a mechanical rotary output;
a DC electrical generator having a generator input connected to the mechanical rotary output and the DC electrical generator operable to produce DC electrical energy at a target voltage when rotated at a target speed; and
a DC-DC converter having an input connected to an electrical output of the DC electrical generator and operable to convert a generator output voltage of the DC electrical generator to a voltage suitable for charging an electric vehicle when the electric vehicle is connected to an output of the DC-DC converter.

12. The system of claim 11, wherein the system is configured and arranged to produce at least ninety kW of electrical output power from the DC-DC converter continuously for at least ten minutes.

13. The system of claim 12, wherein said system is further configured and arranged to deliver at least two hundred amps of current to said electric vehicle continuously for at least ten minutes.

14. The system of claim 11, wherein said prime mover includes an internal combustion engine.

15. The system of claim 11, wherein the system further includes a J1772 compliant or a CHAdeMO compliant electrical connector.

16. The system of claim 11, further comprising a charge controller electrically coupled to the output of the DC-DC converter and communicatively coupled to the prime mover controller, the charge controller and prime mover controller collectively configured and arranged to alter the speed of rotation of the power take off to alter the charging power output of the system.

17. The system of claim 16, wherein the charge controller is further configured to electrically communicate with said electric vehicle.

18. The system of claim 17, wherein the charge controller is further configured to effectuate the alteration of the charging power output of the system in response to information received from said electric vehicle.

19. A method for charging an electric vehicle, comprising:
a. rotating a rotary output of a prime mover that is mechanically connected to an input of a DC electrical generator having an electrical output, the DC electrical generator output electrically connected to an input of a DC-DC converter, and
b. controlling the speed of rotation of the rotary output to adjust the output power of the DC-DC converter suitable to a level sufficient for charging an electric vehicle when the electric vehicle is electrically connected to the electrical output of the DC-DC converter.

20. The method of claim 19 further comprising continually adjusting the output power of the DC-DC converter during charging of said electric vehicle.
